(19) United States
(12) Patent Application Publication
(10) Pub. No.: US 2011/0132005 A1
(43) Pub. Date: Jun. 9, 2011

(54) Refrigeration Process and Apparatus with Subcooled Refrigerant

(76) Inventors: Thomas Edward Kilburn, Pennsburg, PA (US); Michael D. Newman, Hillsborough, NJ (US)

(21) Appl. No.: 12/633,850

(22) Filed: Dec. 9, 2009

(51) Int. Cl. C09K 5/04; F25B 1/00; F28D 7/00; F25B 41/00

(52) U.S. Cl. 62/114; 62/115; 165/159; 62/513

(57) ABSTRACT

A mechanical refrigeration process in which a refrigerant undergoes a cyclical process of evaporation, compression, condensation, and expansion in order to provide a cooling effect, characterized by the condensation of the refrigerant including: supplying the refrigerant to a first side of a heat exchanger; and supplying an exhaust cryogen fluid from a cryogenic process to a second side of the heat exchanger; wherein the exhaust cryogen fluid is capable of subcooling the refrigerant within the heat exchanger. A mechanical refrigeration apparatus is also included capable of subcooling the refrigerant prior to expansion via the use of a cryogen fluid.

The present disclosure is directed to subcooling a refrigerant for a mechanical refrigeration process and/or apparatus via the use of an exhaust cryogen fluid.

Mechanical refrigerators are often used to store products cooled or frozen by a cryogenic process. In these instances, the cryogenic process may include a tunnel freezer, spiral freezer, impingement freezer, or immersion freezer in which a cryogenic fluid is sprayed or otherwise distributed within the freezer in order to cool or freeze the products passing through the tunnel freezer. The products will typically pass into a storage area, which may be kept cold by a mechanical refrigeration process.

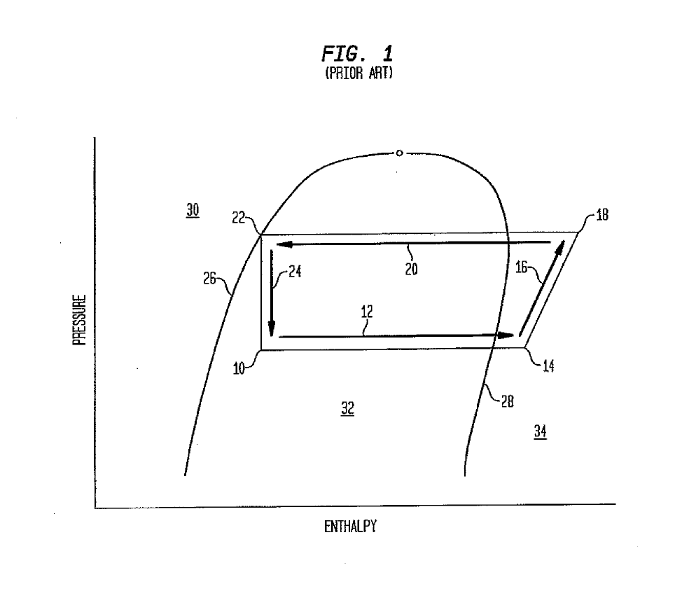

Referring to the pressure-enthalpy diagram of FIG. 1, mechanical refrigeration apparatus typically include a cyclic process whereby a refrigerant passes from a point 10 through an evaporator 12, compressor 16, condenser 20 and expansion valve 24. As the refrigerant passes from point 10 to point 14, it moves from the wet region into the superheated region, withdrawing latent heat from the refrigeration apparatus and providing a cooling effect. The temperature of the refrigerant remains constant through the wet region 32, until it passes into superheated region 34 upon crossing the saturated vapor line 28, at which point the temperature of the refrigerant increases until reaching point 14. As the refrigerant is compressed, represented generally by proceeding along the path from point 14 to point 18, the temperature and pressure of the refrigerant increase substantially. The refrigerant then passes through the condenser 20, represented generally by proceeding along the path from point 18 to point 22, and, via transferring heat to the ambient environment, the temperature decreases through the superheated region 34 until it reaches the saturated vapor line 28, after which the temperature remains constant through the wet region 32 until reaching point 22.

Typical mechanical refrigeration processes are limited in that condensation can reduce the enthalpy of the refrigerant only to the saturated liquid line 26, intersected at point 22. In other words, condensation alone is incapable of pushing point 22 into the subcooled region 30. Since expansion, represented by the refrigerant proceeding along the path from point 22 back to point 10, can occur only as long as point 10 remains within the wet region 32, the efficiency of the refrigeration process may be increased by subcooling the refrigerant prior to expansion. Previous attempts to subcool the refrigerant comprised contacting the condensed refrigerant with a side stream of expanded refrigerant, resulting in an increase in efficiency of only a few percent.

What is needed is a mechanical refrigeration apparatus and/or process which is capable of significantly subcooling the refrigerant after the condensation step, in order to increase the efficiency of the mechanical refrigeration apparatus and/or process.

For a more complete understanding of the present mechanical refrigeration process and apparatus, reference may be made to the following description of the mechanical refrigeration process and apparatus and particular embodiments thereof, in conjunction with the following drawings, of which:

FIG. 1 is a graphical representation of pressure versus enthalpy diagramming the physical properties of the refrigerant as it passes through a mechanical refrigeration process of the prior art.

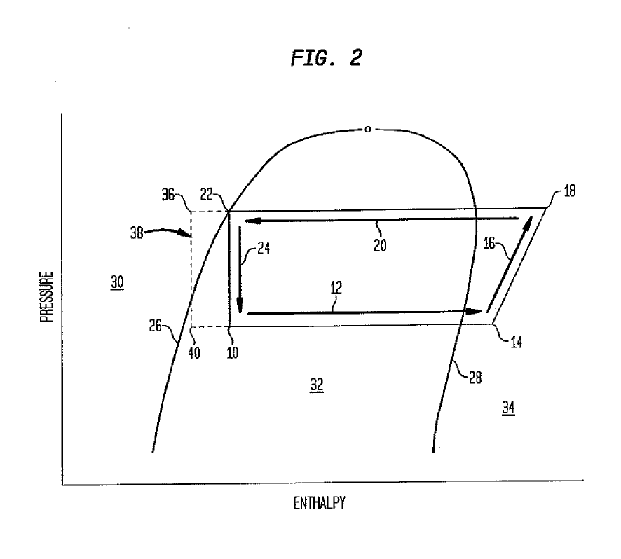

FIG. 2 is a graphical representation of pressure versus enthalpy diagramming the physical properties of the refrigerant as it passes through an embodiment of the present mechanical refrigeration process.

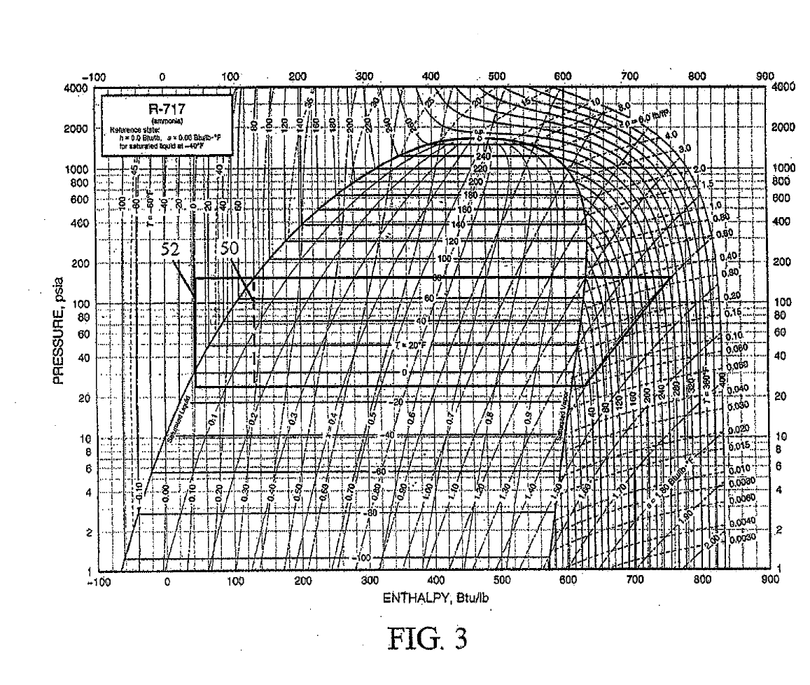

FIG. 3 is a graphical representation of pressure versus enthalpy for ammonia (R-717) diagramming the physical properties of the ammonia as it passes through an embodiment of the present mechanical refrigeration process.

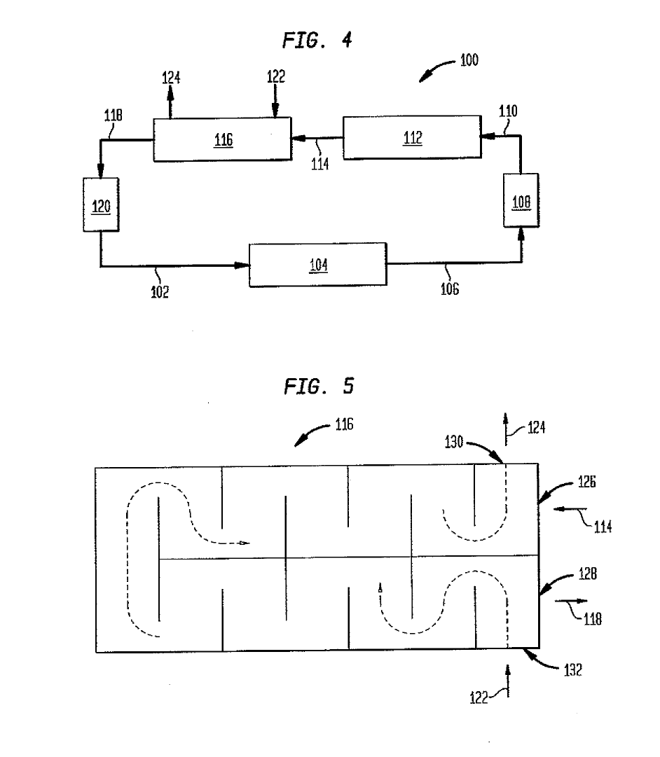

FIG. 4 is a schematic block diagram of one embodiment of the present mechanical refrigeration apparatus and process.

FIG. 5 is a schematic cross-sectional view of one embodiment of the heat exchanger used in FIG. 4 to subcool the refrigerant.

FIG. 6 is a schematic cross-sectional view of another embodiment of the heat exchanger, shown as a one pass tube-side straight-tube heat exchanger.

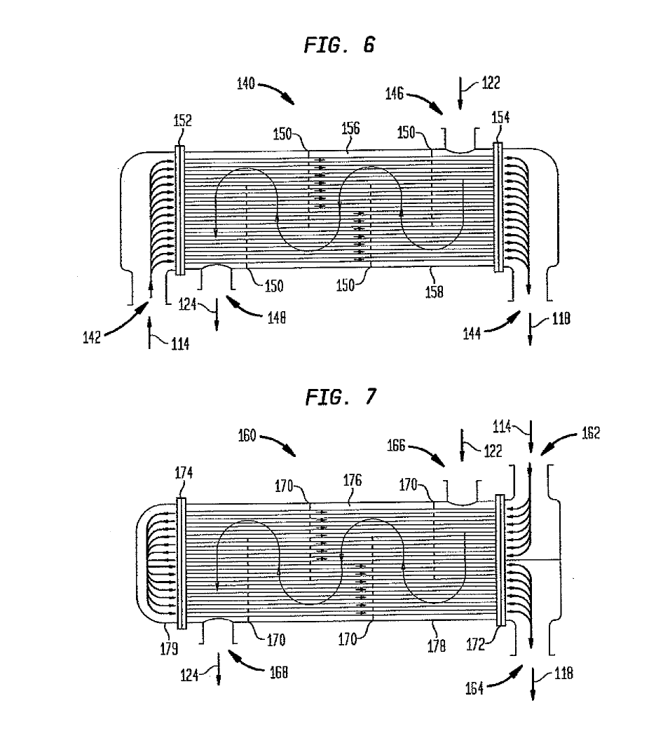

FIG. 7 is a schematic cross-sectional view of another embodiment of the heat exchanger, shown as a two pass tube-side straight-tube heat exchanger.

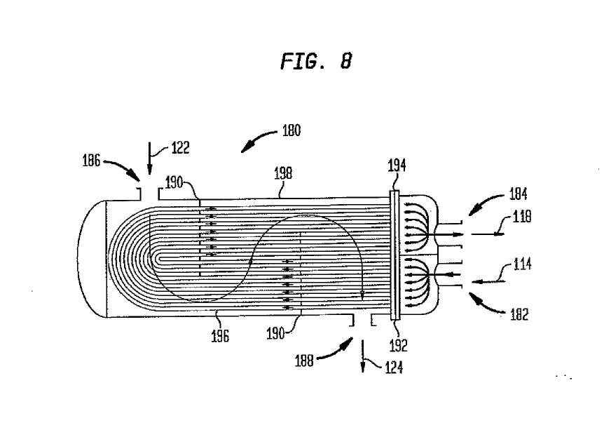

FIG. 8 is a schematic cross-sectional view of another embodiment of the heat exchanger, shown as a U-tube heat exchanger.

A mechanical refrigeration process in which a refrigerant undergoes a cyclical process of evaporation, compression, condensation, and expansion in order to provide a cooling effect is provided, characterized by the condensation of the refrigerant comprising: supplying the refrigerant to a first side of a heat exchanger; and supplying an exhaust cryogen fluid from a cryogenic process to a second side of the heat exchanger; wherein the exhaust cryogen fluid is capable of subcooling the refrigerant within the heat exchanger. The process may further comprise monitoring and/or regulating the amount of subcooling provided by the exhaust cryogen fluid such that, after the subcooling, the refrigerant is still capable of expansion. The monitoring and/or regulating may comprise providing a thermocouple within the mechanical refrigeration process to determine a temperature of the refrigerant upon exiting the heat exchanger, and controlling a volumetric flow rate of the exhaust cryogen fluid, such as by adjusting an exhaust cryogen fluid fan speed, based on the temperature of the refrigerant.

Referring to FIG. 2, the exhaust cryogen fluid provides subcooling to the refrigerant, via the heat exchange relationship provided by the heat exchanger, allowing the refrigerant to pass from point 22 to point 36, into the subcooled region 30. The additional cooling provided by the exhaust cryogen fluid is represented by the region 38, and the benefit of the subcooling is realized by the capability of the refrigerant to now proceed from point 40 to point 10 during evaporation, enabling the refrigerant to extract additional heat from the refrigeration process and/or apparatus.

Also provided is a mechanical refrigeration apparatus comprising a heat exchanger disposed between, and in fluid communication with, a condenser and an expansion valve, the heat exchanger comprising: a first inlet for receiving a refrigerant into a first side of the heat exchanger; a second inlet for receiving a cryogen fluid from a cryogenic process into a second side of the heat exchanger; a first outlet from the first side of the heat exchanger in fluid communication with the expansion valve; and a second outlet from the second side of the heat exchanger for exhausting the cryogen fluid; wherein the cryogen fluid is capable of subcooling the refrigerant within the heat exchanger.

The apparatus may further comprise a device which is capable of monitoring and/or regulating the amount of the subcooling provided by the cryogen fluid such that, after the subcooling is complete, the refrigerant is still capable of evaporation after expansion.

Referring to FIG. 4, an embodiment of the mechanical refrigeration apparatus 100 comprises a cyclic process whereby the refrigerant proceeds through an evaporator 104, a compressor 108, a condenser 112, a heat exchanger 116, and an expansion valve 120. The refrigerant flows through the apparatus 100 in the direction indicated by arrows 102, 106, 110, 114 and 118. The cryogen fluid 122, optionally being exhausted from a separate cryogenic process (not shown), is provided to the heat exchanger 122 and leaves the heat exchanger as warmed exhaust cryogen fluid 124.

The evaporator 104, compressor 108, condenser 112 and expansion valve 120 may each individually comprise any device or apparatus which is capable of providing the desired effect upon the refrigerant. Such devices and/or apparatus are known in the art and are commercially available.

The refrigerant may be ammonia, and the exhaust cryogen fluid may be at least one of nitrogen (N₂), carbon dioxide (CO₂), or air. When the refrigerant is ammonia, subcooling the refrigerant may provide up to an additional about 96 kW of refrigeration capacity for each about 0.45 kg/s of refrigerant.

Referring now to FIG. 5, the refrigeration apparatus and/or process as herein described utilizes the heat exchanger 116. The refrigerant 114 enters the heat exchanger at the tube-side fluid inlet 126. The subcooled refrigerant 118 exits the heat exchanger at the tube-side outlet 128. The cryogen fluid 122 enters the heat exchanger at the shell-side inlet 132. The warmed exhaust cryogen fluid 124 exits the heat exchanger at the shell-side outlet 130. The warmed exhaust cryogen fluid 124 can be vented to the atmosphere, can be utilized in other processes, or can be recycled.

The heat exchanger may be a shell-and-tube heat exchanger, and the refrigerant may be supplied to a tube-side of the shell-and-tube heat exchanger and the cryogen fluid supplied to a shell-side of the shell-and-tube heat exchanger. In various embodiments, the shell-and-tube heat exchanger may comprise a one pass tube-side straight-tube heat exchanger, a two pass tube-side straight-tube heat exchanger, or a U-tube heat exchanger.

FIG. 6 shows a one pass tube-side straight-tube heat exchanger 140 which may be used according to the present process and/or apparatus. The refrigerant 114 enters the heat exchanger 140 at the tube-side inlet 142, passes through: a first tube sheet 152; the tube bundle 156 which utilizes straight tubes; and a second tube sheet 154; before exiting the heat exchanger as subcooled refrigerant 118 at the tube-side outlet 144. The subcooled refrigerant 118 then passes through an expansion valve (not shown).

The cryogen fluid 122 enters the heat exchanger shell 158 at the shell-side inlet 146, passing around the baffles 150 in order to permit increased heat transfer from the refrigerant to the exhaust cryogen fluid, thereby subcooling the refrigerant. The warmed exhaust cryogen fluid 124 then exits the shell 158 at the shell-side outlet 148. The warmed exhaust cryogen fluid 124 can be vented to the atmosphere, can be utilized in other processes, or can be recycled. In the embodiment shown, the colder cryogen fluid is initially in a heat exchange relationship with the subcooled refrigerant.

FIG. 7 shows a two pass tube-side straight-tube heat exchanger 160 which may be used according to the present process and/or apparatus. The refrigerant 114 enters the heat exchanger 160 at the tube-side inlet 162, passes through: the upper portion of a first tube sheet 172; the upper portion of a tube bundle 176 which utilizes straight tubes; and the upper portion of a second tube sheet 174 into a plenum 179. The refrigerant is then redirected through the lower portion of the second tube sheet 174; the lower portion of the tube bundle 176; and the lower portion of the first tube sheet 172; before exiting the heat exchanger as subcooled refrigerant 118 at the tube-side outlet 164. The subcooled refrigerant 118 then passes through an expansion valve (not shown).

The cryogen fluid 122 enters the heat exchanger shell 178 at the shell-side inlet 166, passing around the baffles 170 in order to permit increased heat transfer from the refrigerant to the cryogen fluid, thereby subcooling the refrigerant. The warmed exhaust cryogen fluid 124 then exits the shell 178 at the shell-side outlet 168. The warmed exhaust cryogen fluid 124 can be vented to the atmosphere, can be utilized in other processes, or can be recycled. In this embodiment, the refrigerant can transfer heat to the colder cryogen fluid in two passes: upon entry into the heat exchanger as it passes through the upper portion of the tube bundle, and again before exiting the heat exchanger as it passes through the lower portion of the tube bundle.

FIG. 8 shows a U-tube heat exchanger 180 which may be used according to the present process and/or apparatus. The refrigerant 114 enters the heat exchanger 180 at the tube-side inlet 182, passes through: a first tube sheet 192; the tube bundle 196 which utilizes U-tubes; and a second tube sheet 194; before exiting the heat exchanger as subcooled refrigerant 118 at the tube-side outlet 184. The subcooled refrigerant 118 then passes through an expansion valve (not shown).

The cryogen fluid 122 enters the heat exchanger shell 198 at the shell-side inlet 186, passing around baffles 190 in order to permit increased heat transfer from the refrigerant to the cryogen fluid, thereby subcooling the refrigerant. The warmed exhaust cryogen fluid 124 then exits the shell 198 at the shell-side outlet 188. The warmed exhaust cryogen fluid 124 can be vented to the atmosphere, can be utilized in other processes, or can be recycled.

### EXAMPLE

Assuming that the mass flow of refrigerant through the expansion valve is constant, the increase in refrigeration capacity can be measured according to the following formula:

ΔQ₀=m×Δh

wherein ΔQ₀ is the increase in refrigeration capacity, in is the mass flow rate of refrigerant through the expansion valve, and Δh is the increase in enthalpy provided by subcooling the refrigerant.

Referring again to FIG. 2, in conjunction with FIG. 3, when the refrigerant comprises ammonia (R-717), at point 14, the ammonia has an enthalpy of 622 Btu/lb (1,443 kJ/kg) and a pressure of 24 psia (166 kPa). As the ammonia passes through the compressor 16, it is compressed, and, at point 18 the ammonia mainly comprises a gas having an enthalpy of 753 Btu/lb (1,747 kJ/kg) and a pressure of 180 psia (1242 kPa). After the ammonia passes through the condenser 20 where it changes state at constant pressure and comes to point 22, the ammonia mainly comprises a liquid having an enthalpy of 119 Btu/lb (276 kJ/kg). The liquid ammonia is then subcooled according to the present process and/or apparatus, and proceeds from point 22 to point 36, its enthalpy being reduced to 28 Btu/lb (65 kJ/kg) before expansion. After the ammonia passes through the expansion valve 24 at constant enthalpy, and crosses the saturated liquid line 26, the ammonia is a liquid/gas mixture having a pressure reduced to 24 psia (166 kPa). The ammonia then passes through the evaporator 12 at a constant temperature of −10° F. (−23° C.) and a constant pressure of 24 psia (166 kPa). During evaporation, the ammonia cools the mechanical refrigeration apparatus and/or process, and the enthalpy of the ammonia increases from 28 Btu/lb (65 kJ/kg) to 622 Btu/lb (1,443 kJ/kg) at point 14. Thus, the additional subcooling provided by the cryogen cooled heat exchanger results in the ammonia refrigerant being able to provide an additional 91 Btu/lb (211 kJ/kg) of refrigeration capacity (the enthalpy difference between points 22 and 36).

The increase in refrigerant capacity is also shown in FIG. 3, wherein the refrigerant is ammonia. Subcooling the ammonia provides an additional 91 Btu/lb (211 kJ/kg) of refrigerant enthalpy, represented by the horizontal difference between the hashed vertical line 50 and the solid vertical line 52. Assuming that the mass flow rate in of refrigerant through the expansion valve is 1 pound per second (0.45 kg/s), the increase in refrigeration capacity ΔQ₀ is 91 Btu/s (96 kW). Thus, for every 1 pound per second (0.45 kg/s) of refrigerant flowing through the mechanical refrigeration apparatus, an additional 91 Btu/s (96 kW) of refrigeration capacity is provided, which results in about an 18% increase in overall efficiency of the refrigeration apparatus and/or process.

In a cryogenic cooling or freezing process, where cooled or frozen products are stored in a mechanically refrigerated storage area after exiting the cryogenic process, energy savings and increased efficiency of the mechanical refrigerator are realized by utilization of the present apparatus and/or process. In particular, greater refrigeration capacity, a smaller condenser, and/or lower energy consumption may be realized by the present apparatus and/or process.

It will be understood that the embodiments described herein are merely exemplary and that a person skilled in the art may make many variations and modifications without departing from the spirit and scope of the invention. All such variations and modifications are intended to be included within the present embodiments as described and claimed herein. It should be understood that the embodiments described above are not only in the alternative, but may be combined.

What is claimed is:

1. A mechanical refrigeration process in which a refrigerant undergoes a cyclical process of evaporation, compression, condensation, and expansion in order to provide a cooling effect, characterized by the condensation of the refrigerant comprising:
supplying the refrigerant to a first side of a heat exchanger; and
supplying an exhaust cryogen fluid from a cryogenic process to a second side of the heat exchanger;
wherein the exhaust cryogen fluid is capable of subcooling the refrigerant within the heat exchanger.

2. The process of claim 1, further comprising monitoring and/or regulating the amount of subcooling provided by the exhaust cryogen fluid such that, after the subcooling, the refrigerant is still capable of expansion.

3. The process of claim 2, wherein the monitoring and/or regulating comprises providing a thermocouple within the mechanical refrigeration process to determine a temperature of the refrigerant upon exiting the heat exchanger, and controlling a volumetric flow rate of the exhaust cryogen fluid.

4. The process of claim 3, wherein controlling the volumetric flow rate of the exhaust cryogen fluid comprises adjusting an exhaust cryogen fluid fan speed based on the temperature of the refrigerant.

5. The process of claim 1, wherein the refrigerant is ammonia.

6. The process of claim 5, wherein subcooling the refrigerant provides up to an additional about 96 KW of refrigeration capacity for each about 0.45 kg/s of refrigerant.

7. The process of claim 1, wherein the exhaust cryogen fluid is at least one of nitrogen, carbon dioxide, or air.

8. The process of claim 1, wherein the heat exchanger is a shell-and-tube heat exchanger.

9. The process of claim 8, wherein the refrigerant is supplied to a tube-side of the shell-and-tube heat exchanger, and the exhaust cryogen fluid is supplied to a shell-side of the shell-and-tube heat exchanger.

10. The process of claim 8, wherein the heat exchanger is at least one of a one pass tube-side straight-tube heat exchanger, a two pass tube-side straight-tube heat exchanger, or a U-tube heat exchanger.

11. A mechanical refrigeration apparatus comprising a heat exchanger disposed between, and in fluid communication with, a condenser and an expansion valve, the heat exchanger comprising:
a first inlet for receiving a refrigerant into a first side of the heat exchanger;
a second inlet for receiving a cryogen fluid from a cryogenic process into a second side of the heat exchanger;
a first outlet from the first side of the heat exchanger in fluid communication with the expansion valve; and
a second outlet from the second side of the heat exchanger for exhausting the cryogen fluid;
wherein the cryogen fluid is capable of subcooling the refrigerant within the heat exchanger.

12. The mechanical refrigeration apparatus of claim 11, further comprising a device capable of monitoring and/or regulating the amount of the subcooling provided by the cryogen fluid such that, after the subcooling is complete, the refrigerant is still capable of evaporation after expansion.

13. The mechanical refrigeration apparatus of claim 11, wherein the refrigerant is ammonia.

14. The mechanical refrigeration apparatus of claim 13, wherein the subcooling of the refrigerant provides up to an additional about 96 KW of refrigeration capacity for each about 0.45 kg/s of refrigerant.

15. The mechanical refrigeration apparatus of claim 11, wherein the cryogen fluid is at least one of nitrogen, carbon dioxide, or air.

16. The mechanical refrigeration apparatus of claim 11, wherein the heat exchanger is a shell-and-tube heat exchanger.

17. The mechanical refrigeration apparatus of claim 16, wherein the refrigerant is supplied to a tube-side of the shell-and-tube heat exchanger and the cryogen fluid is supplied to a shell-side of the shell-and-tube heat exchanger.

18. The mechanical refrigeration apparatus of claim 16, wherein the heat exchanger is a one pass tube-side straight-tube heat exchanger.

19. The mechanical refrigeration apparatus of claim 16, wherein the heat exchanger is a two pass tube-side straight-tube heat exchanger.

20. The mechanical refrigeration apparatus of claim 16, wherein the heat exchanger is a U-tube heat exchanger.
